(19) United States
(12) Patent Application Publication
(10) Pub. No.: US 2006/0028176 A1
(43) Pub. Date: Feb. 9, 2006

(54) Cellular telephone battery recharging apparatus

(76) Inventors: Qingfeng Tang, Novi, MI (US); Riad Ghabra, Dearborn Heights, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/896,805

(22) Filed: Jul. 22, 2004

(51) Int. Cl. H02J 7/00

(52) U.S. Cl. 320/114

(57) ABSTRACT

A cellular telephone communication apparatus rechargeable by an exterior power source comprises a housing that includes a rechargeable battery. A secondary inductive coil disposed in the housing is excited by the exterior power source. A control circuit disposed in the housing is electrically connected between the secondary inductive coil and the rechargeable battery for controlling energy flow to the rechargeable battery. A transmitter disposed in the housing is activated for transmitting an identification signal. The identification signal identifies a particular rechargeable battery for recharging.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates in general to a cellular telephone battery recharging system, and more particularly, to a vehicular cellular telephone rechargeable system for determining the compatibility between the recharging unit and the cellular telephone.

2. Description of the Related Art

Cellular telephones typically include rechargeable battery packs which are rechargeable by the use of either a separate plug-in adapter or a docking port which contains electrical contacts to charge the rechargeable batteries in the cellular telephone. The transfer of power from a main power source to the battery pack typically requires providing an output from an AC (alternating current) energy source to a conversion device for rectification to a DC energy source. A regulating circuit may be added to regulate the DC (direct current) energy output to the rechargeable batteries.

Typically such devices include electrical contact members to transfer the converted energy source from the recharging unit to the rechargeable batteries. This requires that electrical contacts of the recharging unit and the electrical contacts of the rechargeable battery pack be fully engaged so that a proper electrical contact can be made for transferring energy. However, damage or short circuiting of the exposed electrical contacts may be the result of debris or foreign material lodged in the electrical contacts.

Other types of recharging methods can be utilized such as inductive charging of the rechargeable battery back. This method uses no electrical contacts between the battery pack and the recharging unit. Rather, a primary coil generates an electromagnetic field to induce an electrical charge on a secondary coil within the battery pack or elsewhere in the cellular telephone. The energy induced in the secondary coil is then converted to a DC energy output for charging the rechargeable battery of the cellular telephone.

However, since a variety of cellular telephone manufacturers produce cellular telephones using unique battery packs of different voltage and current ratings, charging a rechargeable battery pack having a different voltage/current rating than that of the recharging unit may result in damage to either the rechargeable battery pack of the cellular telephone or the recharging unit itself.

Furthermore, cellular telephone recharging systems where the primary coil remains active at all times or during times of engine on uses an unnecessary power consumption, creates excess electromagnetic interference, and may be damaging to other inductive devices that may be in close proximity to the recharging unit when the cellular telephone is not docked in the docking port.

### SUMMARY OF THE INVENTION

The present invention has the advantage of integrating a transmitter within a housing a rechargeable battery pack for transmitting an identification signal to a recharging unit such as a docking port for identifying a particular rechargeable battery for determining recharging compatibility, thereby eliminating the need for a separate fob for the passive entry function.

In one aspect of the present invention, a cellular telephone communication apparatus rechargeable by an exterior power source comprises a housing that includes a rechargeable battery. A secondary inductive coil disposed in the housing is excited by the exterior power source. A control circuit disposed in the housing is electrically connected between the secondary inductive coil and the rechargeable battery for controlling energy flow to the rechargeable battery. A transmitter disposed in the housing is activated for transmitting an identification signal. The identification signal identifies a particular rechargeable battery for recharging.

In yet another aspect of the invention, the transmitter within the cellular telephone communication apparatus transmits an identification signal for activating at least one vehicle passive entry function.

### BRIEF DESCRIPTION OF THE DRAWINGS

FIG. 1 illustrates a perspective view of a wireless cellular telephone.

FIG. 2 illustrates a perspective view of an energy conversion unit for recharging a rechargeable battery.

FIG. 3 illustrates a cellular telephone electrically connected to a docking port for recharging.

FIG. 4 illustrates a cellular telephone and docking port mounted in a vehicle according to a preferred embodiment of the present invention.

FIG. 5 illustrates a cellular telephone ported in a docking port according to a preferred embodiment of the present invention.

FIG. 6 illustrates block diagram of the recharging system according to a preferred embodiment of the present invention.

FIG. 7 illustrates a method for determining the compatibility between rechargeable battery of a cellular telephone and a docking port according to a preferred embodiment of the present invention.

### DETAILED DESCRIPTION OF PREFERRED EMBODIMENTS

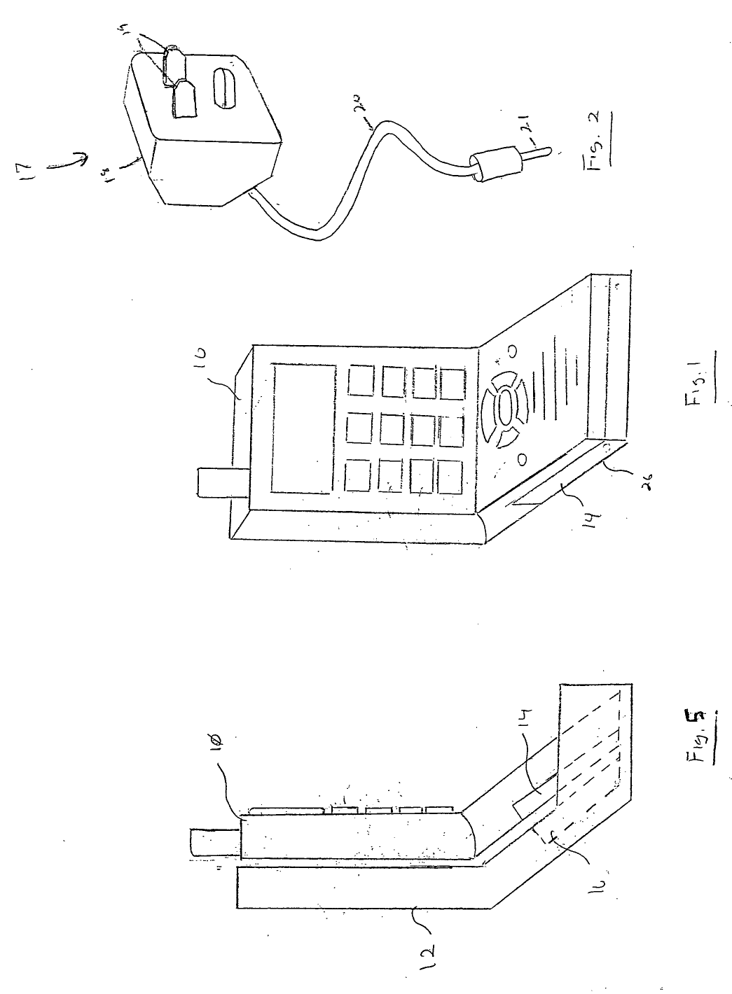

Referring now to the Drawings and particularly to FIG. 1, there is shown a perspective view of a cellular telephone 10 according to the present invention. The cellular telephone 10 is a portable communication device used for transmitting and receiving wireless communication signals. The cellular telephone 10 is powered by a detachable power source such as a rechargeable battery 14. The rechargeable battery 14 is encased in a housing 26 for concealment and protection from exterior elements. The rechargeable battery 14 is re-chargeable while attached to the cellular telephone 10.

Various methods are known for recharging a cellular telephone battery. These methods typically require a direct electrical contact connection to transfer energy from a transmitting power source to the rechargeable battery. FIG. 2 illustrates a typical AC/DC converter unit 17 that is adaptable to the cellular telephone 10 for charging the rechargeable battery 14. The AC/DC converter unit 17 includes a set of male terminals 19 for electrically receiving energy from a household electrical outlet, an energy conversion circuit 18 for converting the energy from AC to DC, a power cord 20 and a male terminal 21 for outputting the DC energy to the cellular telephone 10. The male terminal 21 is inserted into a mating female receptacle (not shown) commonly located on the bottom of a cellular phone. Alternatively, the AC/DC converter unit 17 may include an electrical adapter that is adaptable in an accessory energy port (i.e., cigarette lighter outlet) of a vehicle for receiving input energy and for providing the DC energy to the rechargeable battery 14.

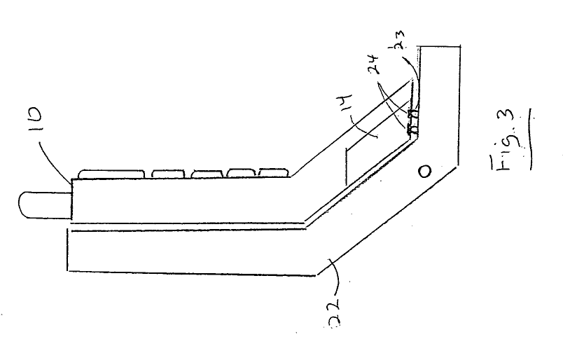

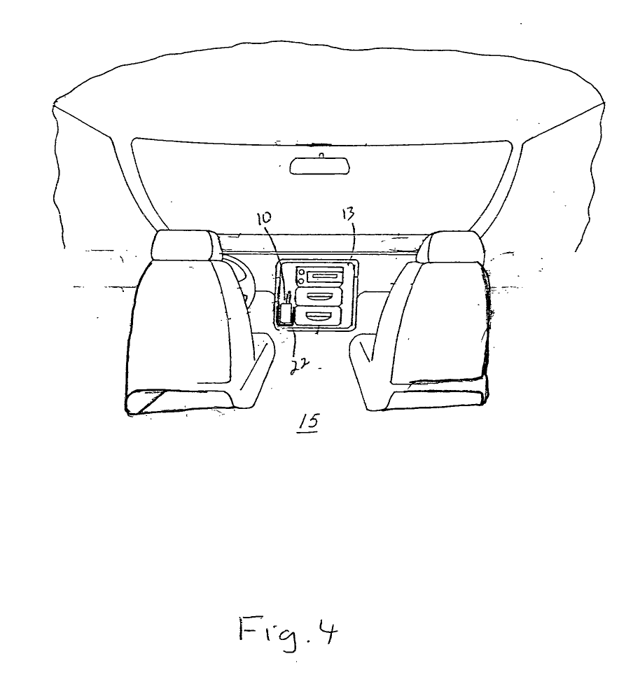

FIG. 3 illustrates yet another common method for recharging the cellular telephone 10 using a docking port 22. The docking port 22 includes a cradle for resting the cellular telephone 10 in a position that is suitable for making electrical contact with contact members 23 of the docking port 22. The docking port 22 further includes an electrical female receptacle (not shown) for receiving the input energy source. The electrical connection may also be hardwired if the docking port 22 is permanently attached to a vehicle. The docking port 22 further includes a conversion circuit for converting the input voltage to a desired DC output voltage. Contact members 23 of the docking port 22 are provided for supplying a DC output voltage to the receiving contact members 24 of rechargeable battery 14. FIG. 4 illustrates the cellular telephone 10 mounted on a central console unit 13 within an interior passenger compartment 15 of a vehicle. The cellular telephone 10 is cradled in the docking port 22 when recharging the rechargeable battery 14. In the preferred embodiment, the docking port 22 is permanently attached to the central console 13. In alternative embodiments, the docking port 22 is detachable from the central console 13 so that the docking port 22 may be utilized in other vehicles, other locations within the vehicle, or other locations outside of the vehicle (e.g., house).

FIG. 5 illustrates a side view of the preferred embodiment of the present invention. The cellular telephone 10 is shown cradled in a docking port 12. The rechargeable battery 14 is disposed on a lower backside surface of the cellular telephone 10. In other preferred embodiments, the rechargeable battery 14 may be adapted to other locations of the cellular telephone 10. The docking port 12 includes an exterior power source 16 that is juxtaposed to the rechargeable battery 14. In the preferred embodiment, the rechargeable battery 14 and the exterior power source 16 are non-contact electrical members such that there are no direct electrical contacts between the recharging battery 14 and the exterior power source 16. Input voltage to the docking port 12 may be directly hardwired or a detachable adapter may be connected to the electrical output port (e.g., cigarette lighter outlet) of the vehicle.

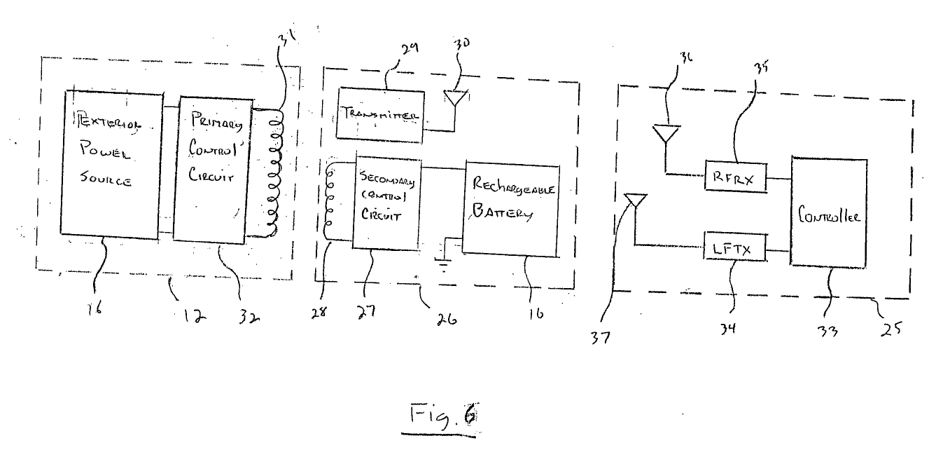

FIG. 6 illustrates a block diagram of the cellular telephone and docking port according to the preferred embodiment of the present invention. The docking port 12 is shown to include the exterior power source 16. As stated supra, the exterior power source 16 receives its energy input from an energy storage device or energy generating device within the vehicle such as a vehicle battery or an alternator. The exterior power source 16 includes circuitry for converting the input power to a desired AC energy output. The energy is provided to a primary control circuit 32 for regulating and controlling the state of charge of the energy generated on a primary inductive coil 31. The primary control circuit 32 also includes a sensing circuit which will be discussed in detail infra.

The housing 26 is adaptable to the cellular telephone 12 which encases and protects the rechargeable battery 16 from exterior elements. The housing 26 further includes a secondary control circuit 27 and a secondary inductive coil 28. The secondary control circuit 27 includes circuitry for rectifying an induced AC output from the secondary inductive coil 28 for recharging the rechargeable battery 16.

To assist a user in determining charging compatibility between the respective rechargeable battery of a respective cellular telephone and the docking port 12, an apparatus is provided for automatically determining recharging compatibility. A transmitter 29 and an antenna 30 are provided within the housing 26 for transmitting an identification signal identifying the rechargeable battery. For example, various manufacturers provide cellular telephone batteries of different voltage ratings as well as different battery-cell compositions. In the preferred embodiment, the transmitter 29 includes a transponder. The transponder is used to transmit the identification signal identifying the rechargeable battery 16 when recharging is initiated or about to commence. The transponder is energized by an electromagnetic field having a respective strength. The electromagnetic field may be one that is generated by the primary induction coil 31 or any other vehicle radiated signal. This process may be initiated by the user placing the cellular telephone 10 in the docking port 22. The transponder broadcasts an identification signal via antenna 30 to the sensing circuit of the docking port 12 or vehicle. Preferably, the sensing circuit may be integrated with the primary control circuit 32, however, in alternative embodiments, the sensing circuit may be an independent circuit within the docking port 12. After the sensing circuit receives the identification signal, the sensing circuit compares the broadcast identification signal to an identification code stored in memory of the sensing circuit. If the identification codes matches identification signal, the power is provided to the primary inductive coil 31 for inductively charging the rechargeable battery 16. If the identification signal does not match, then the charging of the rechargeable battery 16 is terminated to prevent potential damage to the rechargeable battery 16 or the docking port 12.

In other preferred embodiments, the sensing circuit within the docking port 12 may determine the compatibility between the rechargeable battery 16 and the docking port 12 by means other than receiving the identification signal from the transponder. Such means includes sensing the amount of induced voltage on the secondary induction coil 28. An amount greater or less than a predetermined voltage differential would indicate that incompatibility condition is present and charging should be terminated. Termination of the charging of the rechargeable battery 12 could be performed automatically by electrically controlling the input voltage or output voltage. Alternatively, an indicator light could signal the user that an incompatibility condition is present and indicate that the cellular telephone 10 should be manually removed from the docking port 12.

In another preferred embodiment, other types of control circuitry could be integrated for controlling the charge of the rechargeable battery. Such examples include a measurement circuit for measuring the voltage and/or current to the rechargeable battery for determining the state of charge of the rechargeable battery 12. In yet another embodiment, a temperature sensor could be integrated for ascertaining the state of temperature for determining an overheating condition of the rechargeable battery 12. In yet another preferred embodiment, a fail safe circuit can be utilized for terminating the charging of the rechargeable battery 12 when an overload condition is detected or when unordinary amounts of energy are being conducted to the rechargeable battery.

FIG. 6 further illustrates another preferred embodiment for using electrical components of the cellular telephone charging system to perform a passive entry function. The transmitter 29 is in communication with a vehicle electronic control module 25 for activating a vehicle passive entry function. The electronic control module 25 disposed within the vehicle includes a controller 33 for controlling the transmission and processing of the input/output signals to and from the electronic control module 25. The electronic control module 25 includes a low frequency transmitter (LFTX) 34 connected to a low frequency transmitting antenna 37 for transmitting low frequency signals. The electronic control module 25 further includes a high frequency receiver (RFRX) 35 connected to a high frequency antenna 36 for receiving high frequency signals. The electronic control module is connected to an actuation switch or other similar device for activating a passive entry function. Such passive entry functions include a door unlock function, an engine start function, and an immobilization function.

The transmitter 29 of the cellular telephone 10 receives an interrogating signal from the vehicle initiating the passive entry operations. A user may initiate the process for broadcasting the interrogating signal by generating a user request such as lifting a door handle of a vehicle. This generates a door unlock request. The electronic control module 25 responds to the request by broadcasting the interrogating signal. The transmitter 29 broadcasts the identification signal in response to the received interrogation signal. The identification signal may be encrypted or a rolling identification code may be used to deter theft or electronic eavesdropping of the identification signal. If the identification signal matches the code stored in the memory of the electronic control module 33, a control signal is output to activate the one of the passive entry vehicle functions.

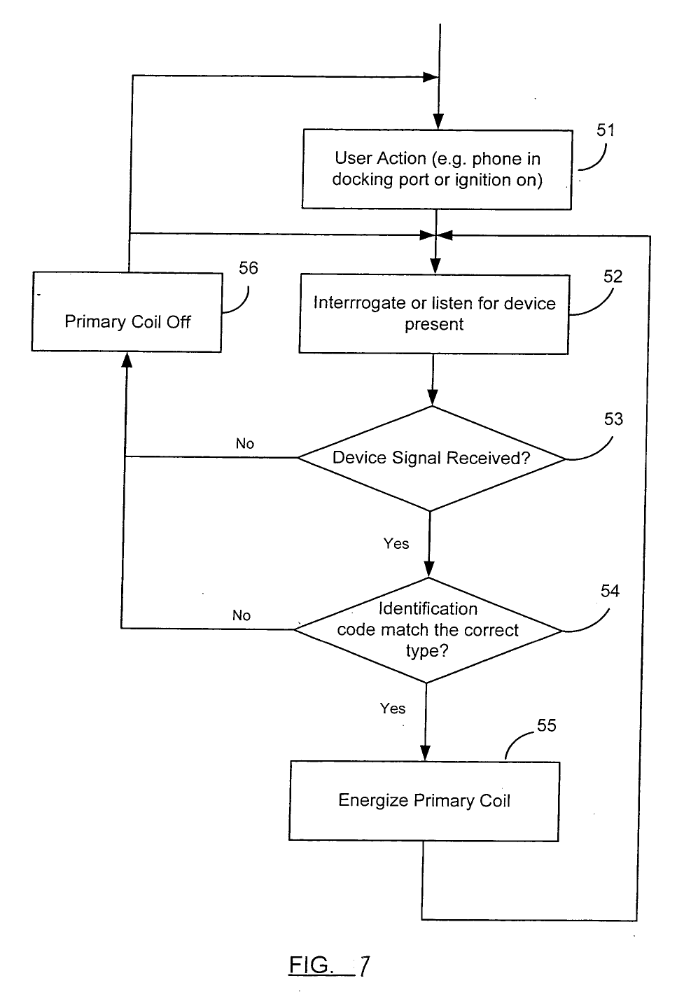

FIG. 7 illustrates a preferred embodiment of a method for determining the compatibility between the rechargeable battery of the cellular telephone and the docking port. In step 51, a user invokes an action to begin charger operation such as docking a cellular telephone in a docking port having an interlock switch or turning the ignition on. In step 52, the docking port interrogates the transponder by providing an interrogation signal to the transponder (which may include energizing the transponder by an electromagnetic field if necessary). Alternatively, the docking port may listen for the rechargeable battery such as sensing for an electromagnetic field of a predetermined strength.

In step 53, a determination is made whether the device signal is received. If a determination is made that the device signal is not received by the docking port, no energy is transmitted through the primary coil. In the preferred embodiment, the primary coil is normally inactive until activated. If a determination was made in step 53 that the device signal is received, then a determination is made in step 54 whether a code within the identification signal matches the code stored within the memory of the docking port. If the code within the identification signal matches the code within the docking port, then the primary coil is energized as appropriate for the particular battery identified in step 55 and a return is made to step 52 to wait for an interrogation signal or listen for the device. If a determination was made in step 54 that the identification codes did not match, then the primary coil is not energized in step 56 and a return is made to step 51 to await a user action. Alternatively a return could be made to step 52 to wait for the interrogation signal or listen for the device.

What is claimed is:

1. A cellular telephone communication apparatus rechargeable by an exterior power source, the apparatus comprising:
a housing including a rechargeable battery;
a secondary inductive coil disposed in said housing excited by said exterior power source;
a control circuit disposed in said housing and electrically connected between said secondary inductive coil and said rechargeable battery for controlling energy flow to said rechargeable battery; and
a transmitter disposed in said housing wherein said transmitter is activated for transmitting an identification signal, said identification signal identifying a particular rechargeable battery for recharging.

2. The apparatus of claim 1 wherein said transmitter is comprised of a transponder.

3. The apparatus of claim 1 wherein said transmitter transmits said identification signal for activating at least one vehicle passive entry function.

4. A portable convenience system comprising:
a recharging port including an exterior power source, said port mounted in a vehicle; and
a portable electronic device for performing a user convenience function, said portable electronic device including a rechargeable battery pack comprising:
a rechargeable battery disposed in said battery pack;
a secondary inductive coil disposed in said battery pack that is excited by said exterior power source;
a control circuit electrically connected between said secondary inductive coil and said rechargeable battery for controlling energy flow to said rechargeable battery; and
a transmitter for transmitting identification signals;
wherein said recharging port further includes a sensing circuit for receiving said identification signals from said transmitter, said identification signal identifying a particular rechargeable battery for recharging.

5. The system of claim 4 wherein said portable electronic device includes a cellular telephone.

6. The system of claim 4 wherein said transmitter includes a transponder energized by said exterior power source.

7. The system of claim 4 wherein said exterior power source includes a self-contained power source.

8. The system of claim 4 wherein said exterior power source includes a primary inductive coil disposed in said recharging port.

9. The system of claim 4 wherein said transmitter transmits said identification signal for activating at least one passive entry function in conjunction with said vehicle.

10. A vehicle convenience system comprising:
a vehicle including an interior compartment;
a recharging port including an exterior power source, said recharging port mounted in said interior compartment of said vehicle;
a sensing circuit disposed in said vehicle; and
wherein said recharging port is adaptable to receive a portable electronic device, wherein said sensing circuit receives an identification signal identifying said portable electronic device as compatible for recharging, said recharging port recharges said portable electronic device in response to said identification signal.

11. The vehicle system of claim 10 wherein said portable electronic device includes a cellular telephone.

12. The vehicle system of claim 10 wherein said sensing circuit is disposed in said recharging port.

13. The vehicle system of claim 10 further comprising an electronic control module, said electronic control module receives said identification signal for activating a vehicle passive entry function.

14. A method of recharging a rechargeable battery pack within a cellular telephone from a power source exterior to said rechargeable battery pack within a vehicle, said method comprising the steps of:
providing a housing disposed in said cellular telephone which includes a rechargeable battery, a secondary inductive coil, a control circuit, and a transmitter;
energizing said transmitter in response to a user action to broadcast an identification signal;
exciting said secondary inductive coil disposed in said housing by said exterior power source in response to said identification signal; and
controlling the flow of energy to said at least one rechargeable battery from said secondary inductive coil.

15. The method of claim 14 wherein said identification signal identifies a particular rechargeable battery for recharging.

16. The method of claim 14 wherein a sensing circuit senses receives said identification signal identifying said rechargeable battery pack.

17. The method of claim 14 wherein said identification signal is received by an electronic control module for determining whether a passive entry function should be activated for allowing access to a vehicle.

18. The method of claim 17 wherein said passive entry function includes a vehicle door unlock function for unlocking a vehicle door.

19. The method of claim 17 wherein said passive entry function includes an engine start function deactivating engine immobilizer.

20. The method of claim 14 wherein said transmitter is energized by said exterior power source.
